(19) United States
(12) Patent Application Publication
(10) Pub. No.: US 2017/0071012 A1
(43) Pub. Date: Mar. 9, 2017

(54) BASE STATION, USER EQUIPMENT AND ASSOCIATED METHODS

(71) Applicants: Qi Jiang, Park, Pudong New Dist., Shanghai (CN); Sharp Kabushiki Kaisha, Sakai City, Osaka (JP)

(72) Inventors: Qi Jiang, Shanghai (CN); Renmao Liu, Shanghai (CN); Bo Li, Shanghai (CN)

(21) Appl. No.: 15/309,080

(22) PCT Filed: May 6, 2015
(86) PCT No.: PCT/CN2015/078387

§ 371 Date: Nov. 4, 2016

(30) Foreign Application Priority Data
May 7, 2014 (CN) 201410190397.5

(51) Int. Cl. H04W 72/12; H04W 72/04

(52) U.S. Cl. CPC H04W 72/1294; H04W 72/0446; H04W 72/1273; H04W 76/023

(57) ABSTRACT

The present disclosure provides a User Equipment (UE). The UE comprises: a receiving unit configured to receive from a base station Device-to-Device (D2D) grant information and D2D indication information indicating a first position relation between a subframe for receiving the D2D grant information and a first start subframe to be used by the UE for transmitting a D2D Scheduling Assignment (SA); a determining unit configured to determine the first start subframe to be used by the UE for transmitting the D2D SA based on the first position relation; and a transmitting unit configured to start transmission of the D2D SA from the first start subframe.

### TECHNICAL FIELD

The present disclosure relates to wireless communications, and more particularly, to a base station, a User Equipment (UE) and associated methods.

### BACKGROUND

Modern wireless mobile communication systems have two significant characteristics. The first one is broadband and high rate. For example, the fourth generation wireless mobile communication systems have up to 100 MHz of bandwidth and up to 1 Gbps of downlink rate. The second one is mobile interconnecting, which enables emerging services such as mobile internet, mobile video on demand, online navigation, and the like. These two characteristics have higher requirements on the wireless mobile communication technology, including ultrahigh rate wireless transmission, inter-area interference suppression, reliable signal transmission while moving, distributed/centered signal processing, etc. In the enhanced fourth generation (4G) and the fifth generation (5G) in the future, in order to meet the above development requirements, various key techniques have been proposed and discussed, and are worth extensive attention of researchers in the related field.

In October of 2007, the International Telecom Union (ITU) has approved the Worldwide Interoperability for Microwave Access (WiMAX) as the fourth 3G system standard. This event, which happened at the end of the 3G era, is in fact a rehearsal of the 4G standard war. Indeed, in order to confront the challenges from the wireless IP technology represented by wireless local area network (WLAN) and WiMAX, the 3GPP organization has set out to prepare for its new system upgrade—standardization of the Long Term Evolution (LTE) system. As a quasi-4G system which is based on Orthogonal Frequency Division Multiplexing (OFDM), the LTE system had its first release published in 2009, and was subsequently put into commercial use in 2010. Meanwhile, the standardization of the 4G wireless mobile communication system was also started by 3GPP in the first half of 2008, and this system were referred to as Long Term Evolution Advanced (LTE-A). The critical standard specification for physical layer procedures of that system was completed in early 2011. In November of 2011, the ITU officially announced in Chongqing, China that the LTE-A system and the WiMAX system are two official standards for 4G systems. Nowadays, global commercialization of the LTE-A system is progressing step by step.

According to the challenges of the next decade, the enhanced fourth generation wireless mobile communication systems have generally the following development requirements:
Higher wireless broadband rate and optimization of local cell hot spots;
Further improved user experience, especially optimization of communication services for cell border areas;
Continuous researches on new techniques capable of improving spectral utilization, due to impossibility of 1,000 times of expansion of available spectrums;
Use of high frequency spectrums (5 GHz or even higher) to obtain large communication bandwidth;
Cooperation with existing networks (2G/3G/4G, WLAN, WiMax, etc.) to share data traffic;
Specific optimization for different traffics, applications and services;
Enhanced system capabilities for supporting large scale Machine Type Communications;
Flexible, intelligent and inexpensive network planning and deployment; and
Designs for saving power consumptions of networks and UE batteries.

In order to achieve the above development requirements, the 3^{rd} Generation Partner Project (3GPP) organization has discussed and accepted Device-to-Device (D2D) communication technique as a key technique in the enhanced fourth generation wireless mobile communication systems.

The D2D technique allows local communications or peer-to-peer communications, without access to core networks. With transmissions based on the D2D technique, loads on base stations can be effectively reduced and life time of mobile terminal batteries can be effectively prolonged. Generally, according to the whether there is coverage of a macro base station in the environment where UEs for D2D transmissions (referred to as D2D UEs hereinafter) are located, scenarios for the D2D UEs can be divided into network coverage, no network coverage and partial network coverage. In the partial network coverage scenario, there are D2D UEs with network coverage and D2D UEs without network coverage.

Currently, for D2D communications, especially those with coverage of base station, 3GPP has decided to use Physical Downlink Control Channel (PDCCH) and Enhanced PDCCH (EPDCCH) for transmitting D2D grant information for D2D Scheduling Assignment (SA) and D2D data (DATA). When a D2D UE receives a subframe contain the D2D grant information, it can transmit D2D SA and D2D data to another D2D UE based on the grant information. However, after receiving the subframe containing the D2D grant information from the base station, the UE does not know from which subframe it should start transmitting the D2D SA and D2D data.

There is thus a need for a new control scheme for controlling a timing relation between a subframe for D2D grant information and a start subframe for D2D transmission (i.e., D2D SA or D2D data) from a UE.

### SUMMARY

It is an object of the present disclosure to provide a base station, a UE and associated methods, capable of controlling a timing relation between a subframe for D2D grant information and a start subframe for D2D transmission from a UE.

In a first aspect of the present disclosure, a method in a base station is provided. The method comprises: transmitting to a User Equipment (UE) Device-to-Device (D2D) grant information; and transmitting to the UE D2D indication information indicating a first position relation between a subframe for transmitting the D2D grant information and a first start subframe to be used by the UE for transmitting a D2D Scheduling Assignment (SA).

In an embodiment, the D2D indication information further indicates a second position relation between the subframe for transmitting the D2D grant information and a second start subframe to be used by the UE for transmitting a D2D data.

In an embodiment, the method further comprises: transmitting to the UE further D2D grant information; and transmitting to the UE further D2D indication information indicating a second position relation between the subframe for transmitting the D2D grant information and a second start subframe to be used by the UE for transmitting a D2D data.

In a second aspect of the present disclosure, a method in a User Equipment (UE) is provided. The method comprises: receiving from a base station Device-to-Device (D2D) grant information; receiving from the base station D2D indication information indicating a first position relation between a subframe for receiving the D2D grant information and a first start subframe to be used by the UE for transmitting a D2D Scheduling Assignment (SA); determining the first start subframe to be used by the UE for transmitting the D2D SA based on the first position relation; and starting transmission of the D2D SA from the first start subframe.

In an embodiment, the D2D indication information further indicates a second position relation between the subframe for receiving the D2D grant information and a second start subframe to be used by the UE for transmitting a D2D data. The method further comprises: determining the second start subframe to be used by the UE for transmitting the D2D data based on the second position relation; and starting transmission of the D2D data from the second start subframe.

In an embodiment, the method further comprises: receiving from the base station further D2D grant information; and receiving from the base station further D2D indication information indicating a second position relation between the subframe for receiving the D2D grant information and a second start subframe to be used by the UE for transmitting a D2D data. The method further comprises: determining the second start subframe to be used by the UE for transmitting the D2D data based on the second position relation; and starting transmission of the D2D data from the second start subframe.

In a third aspect of the present disclosure, a base station is provided. The base station comprises: a first transmitting unit configured to transmit to a User Equipment (UE) Device-to-Device (D2D) grant information; and a second transmitting unit configured to transmit to the UE D2D indication information indicating a first position relation between a subframe for transmitting the D2D grant information and a first start subframe to be used by the UE for transmitting a D2D Scheduling Assignment (SA).

In an embodiment, the D2D indication information further indicates a second position relation between the subframe for transmitting the D2D grant information and a second start subframe to be used by the UE for transmitting a D2D data.

In an embodiment, the first transmitting unit is further configured to transmit to the UE further D2D grant information; and the second transmitting unit is further configured to transmit to the UE further D2D indication information indicating a second position relation between the subframe for transmitting the D2D grant information and a second start subframe to be used by the UE for transmitting a D2D data.

In a fourth aspect of the present disclosure, a User Equipment (UE) is provided. The UE comprises: a receiving unit configured to receive from a base station Device-to-Device (D2D) grant information and D2D indication information indicating a first position relation between a subframe for receiving the D2D grant information and a first start subframe to be used by the UE for transmitting a D2D Scheduling Assignment (SA); a determining unit configured to determine the first start subframe to be used by the UE for transmitting the D2D SA based on the first position relation; and a transmitting unit configured to start transmission of the D2D SA from the first start subframe.

In an embodiment, the D2D indication information further indicates a second position relation between the subframe for receiving the D2D grant information and a second start subframe to be used by the UE for transmitting a D2D data, the determining unit is further configured to determine the second start subframe to be used by the UE for transmitting the D2D data based on the second position relation, and the transmitting unit is further configured to start transmission of the D2D data from the second start subframe.

In an embodiment, the receiving unit is further configured to receive from the base station further D2D grant information and further D2D indication information indicating a second position relation between the subframe for receiving the D2D grant information and a second start subframe to be used by the UE for transmitting a D2D data, the determining unit is further configured to determine the second start subframe to be used by the UE for transmitting the D2D data based on the second position relation, and the transmitting unit is further configured to start transmission of the D2D data from the second start subframe.

In a fifth embodiment of the present disclosure, a method in a User Equipment (UE) is provided. The method comprises: receiving from a base station Device-to-Device (D2D) grant information; determining a first start subframe to be used by the UE for transmitting a D2D Scheduling Assignment (SA) based on a first predetermined relation between a subframe for receiving the D2D grant information and the first start subframe to be used by the UE for transmitting the D2D SA; and starting transmission of the D2D SA from the first start subframe.

In an embodiment, the method further comprises: starting transmission of a D2D data from the first start subframe.

In an embodiment, the first start subframe is the first subframe, subsequent to a subframe for receiving the D2D grant information, among subframes pre-allocated for D2D traffic.

In an embodiment, the first start subframe is the k-th subframe subsequent to a subframe for receiving the D2D grant information, where k is an integer larger than or equal to 1.

In an embodiment, the method further comprises: determining a second start subframe to be used by the UE for transmitting a D2D data based on a second predetermined relation between a subframe for receiving the D2D grant information and the second start subframe to be used by the UE for transmitting the D2D data; and starting transmission of the D2D data from the second start subframe.

In an embodiment, the second start subframe is the first subframe, subsequent to a subframe for receiving the D2D grant information, among subframes pre-allocated for D2D traffic.

In an embodiment, the second start subframe is the m-th subframe subsequent to a subframe for receiving the D2D grant information, where m is an integer larger than or equal to 1.

In a sixth aspect of the present disclosure, a User Equipment (UE) is provided. The UE comprises: a receiving unit configured to receive from a base station Device-to-Device (D2D) grant information; a determining unit configured to determine a first start subframe to be used by the UE for transmitting a D2D Scheduling Assignment (SA) based on a first predetermined relation between a subframe for receiving the D2D grant information and the first start subframe to be used by the UE for transmitting the D2D SA; and a transmitting unit configured to start transmission of the D2D SA from the first start subframe.

In an embodiment, the transmitting unit is further configured to start transmission of a D2D data from the first start subframe.

In an embodiment, the first start subframe is the first subframe, subsequent to a subframe for receiving the D2D grant information, among subframes pre-allocated for D2D traffic.

In an embodiment, the first start subframe is the k-th subframe subsequent to a subframe for receiving the D2D grant information, where k is an integer larger than or equal to 1.

In an embodiment, the determining unit is further configured to determine a second start subframe to be used by the UE for transmitting a D2D data based on a second predetermined relation between a subframe for receiving the D2D grant information and the second start subframe to be used by the UE for transmitting the D2D data; and the transmitting unit is further configured to start transmission of the D2D data from the second start subframe.

In an embodiment, the second start subframe is the first subframe, subsequent to a subframe for receiving the D2D grant information, among subframes pre-allocated for D2D traffic.

In an embodiment, the second start subframe is the m-th subframe subsequent to a subframe for receiving the D2D grant information, where m is an integer larger than or equal to 1.

With the embodiments according to the present disclosure, a UE can determine a start subframe for D2D transmission (D2D SA and/or D2D data) based on a subframe position relation between a subframe used for D2D grant information and the start subframe for D2D transmission. Here, the subframe position relation can be dynamically indicated by D2D indication information received from a base station, or can be pre-determined statically.

### BRIEF DESCRIPTION OF THE DRAWINGS

The above and other objects, features and advantages will be more apparent from the following description of embodiments with reference to the figures, in which:

FIG. 1 is a block diagram of a base station according to an embodiment of the present disclosure;

FIG. 2 is a flowchart illustrating a method in a base station according to an embodiment of the present disclosure;

FIG. 3 is a block diagram of a UE according to an embodiment of the present disclosure;

FIG. 4 is a flowchart illustrating a method in a UE according to an embodiment of the present disclosure;

FIG. 5 is a block diagram of a UE according to another embodiment of the present disclosure; and

FIG. 6 is a flowchart illustrating a method in a UE according to another embodiment of the present disclosure.

### DETAILED DESCRIPTION

In the following, preferred embodiments of the present disclosure will be described in detail with reference to the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

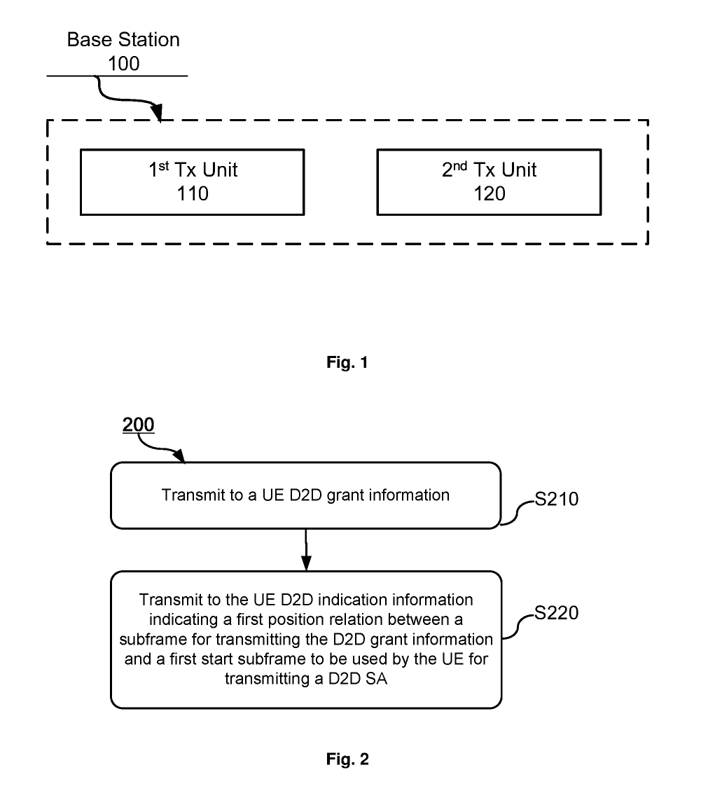

FIG. 1 is a block diagram of a base station 100 according to an embodiment of the present disclosure. As shown in FIG. 1, the base station 100 includes a first transmitting unit 110 and a second transmitting unit 120. It can be appreciated by those skilled in the art that the base station 100 further includes other functional units necessary for its functionality, e.g., various processors, memories and the like.

The first transmitting unit 110 is configured to transmit to a User Equipment (UE) Device-to-Device (D2D) grant information.

The second transmitting unit 120 is configured to transmit to the UE D2D indication information indicating a first position relation between a subframe for transmitting the D2D grant information and a first start subframe to be used by the UE for transmitting a D2D Scheduling Assignment (SA).

In the context of the present disclosure, a “position relation” between a subframe A and a subframe B can be represented as a difference between their subframe numbers. Accordingly, the D2D indication information here can indicate a difference between the subframe number of the subframe for transmitting the D2D grant information and the subframe number of the first start subframe to be used by the UE for transmitting the D2D SA. For example, assuming that the subframe number of the subframe for transmitting the D2D grant information is x and the difference indicated by the D2D indication information is y, the D2D indication information indicates that the UE starts transmission of the D2D SA from the subframe having a subframe number of z=x+y.

As an example, the D2D indication information may be provided in bits in an existing Downlink Control Information (DCI) format transmitted over PDCCH or EPDCCH. For example, if the transmitted DCI format is Format 0, unused bits in the D2D grant information can be used for transmission of the D2D indication information. For example, some or all of the bits in New Data Indicator, Transmit Power Control (TPC) Command, Cyclic Shift, Uplink (UL) Index, Downlink Assignment Index, Channel State Information (CSI) Request, Sounding Reference Signal (SRS) Request, or Resource Allocation Type can be used for transmission of the D2D indication information.

Alternatively, the D2D indication information can be provided in bits in a new DCI format transmitted over PDCCH or EPDCCH.

Alternatively, the D2D indication information can be provided in one or more of System Information Broadcast (SIB) 1˜SIB 16.

Alternatively, the D2D indication information can be provided in a UE-specific Radio Resource Control (RRC) signaling. In this case, the UE-specific RRC signaling may be e.g., RadioResourceConfigDedicated Information Element (IE).

Alternatively, the UE-specific RRC signaling can be an RRCConnectionSetup message.

Optionally, the D2D indication information can further indicate a second position relation between the subframe for transmitting the D2D grant information and a second start subframe to be used by the UE for transmitting a D2D data.

Alternatively, the first transmitting unit 110 can be further configured to transmit to the UE further D2D grant information. The second transmitting unit 120 can be further configured to transmit to the UE further D2D indication information indicating a second position relation between the subframe for transmitting the D2D grant information and a second start subframe to be used by the UE for transmitting a D2D data.

The examples described above in connection with the transmission of the D2D indication information also apply to the further D2D indication information.

FIG. 2 is a flowchart illustrating a method 200 in a base station according to an embodiment of the present disclosure. It is to be noted that all the features described above in connection with the above embodiment of the base station 100 also apply to the following method embodiment. The method 200 can be performed by the above base station 100 and include the following steps.

At step S210, Device-to-Device (D2D) grant information is transmitted to a User Equipment (UE).

At step S220, D2D indication information is transmitted to the UE, indicating a first position relation between a subframe for transmitting the D2D grant information and a first start subframe to be used by the UE for transmitting a D2D Scheduling Assignment (SA).

Optionally, in the step S220, the D2D indication information can further indicate a second position relation between the subframe for transmitting the D2D grant information and a second start subframe to be used by the UE for transmitting a D2D data.

Alternatively, the method 200 can further include (not shown) a step of transmitting to the UE further D2D grant information and further D2D indication information indicating a second position relation between the subframe for transmitting the D2D grant information and a second start subframe to be used by the UE for transmitting a D2D data.

FIG. 3 is a block diagram of a UE 300 according to an embodiment of the present disclosure. As shown in FIG. 3, the UE 300 includes a receiving unit 310, a determining unit 320 and a transmitting unit 330. It can be appreciated by those skilled in the art that the UE 300 further includes other functional units necessary for its functionality, e.g., various processors, memories and the like.

The receiving unit 310 is configured to receive from a base station Device-to-Device (D2D) grant information and D2D indication information indicating a first position relation between a subframe for receiving the D2D grant information and a first start subframe to be used by the UE for transmitting a D2D Scheduling Assignment (SA).

The determining unit 320 is configured to determine the first start subframe to be used by the UE for transmitting the D2D SA based on the first position relation.

The transmitting unit 330 is configured to start transmission of the D2D SA from the first start subframe.

As described above, the D2D indication information here can indicate a difference between the subframe number of the subframe for transmitting the D2D grant information and the subframe number of the first start subframe to be used by the UE for transmitting the D2D SA. For example, assuming that the subframe number of the subframe for transmitting the D2D grant information is x and the difference indicated by the D2D indication information is y, the D2D indication information indicates that the UE starts transmission of the D2D SA from the subframe having a subframe number of z=x+y.

Optionally, the D2D indication information further indicates a second position relation between the subframe for receiving the D2D grant information and a second start subframe to be used by the UE for transmitting a D2D data. In this case, the determining unit 320 is further configured to determine the second start subframe to be used by the UE for transmitting the D2D data based on the second position relation. The transmitting unit 330 is further configured to start transmission of the D2D data from the second start subframe.

Alternatively, the receiving unit 310 is further configured to receive from the base station further D2D grant information and further D2D indication information indicating a second position relation between the subframe for receiving the D2D grant information and a second start subframe to be used by the UE for transmitting a D2D data. In this case, the determining unit 320 is further configured to determine the second start subframe to be used by the UE for transmitting the D2D data based on the second position relation. The transmitting unit 330 is further configured to start transmission of the D2D data from the second start subframe.

Regarding the D2D indication information and the further D2D indication information, the examples described above in connection with the base station 100 also apply to the UE 300.

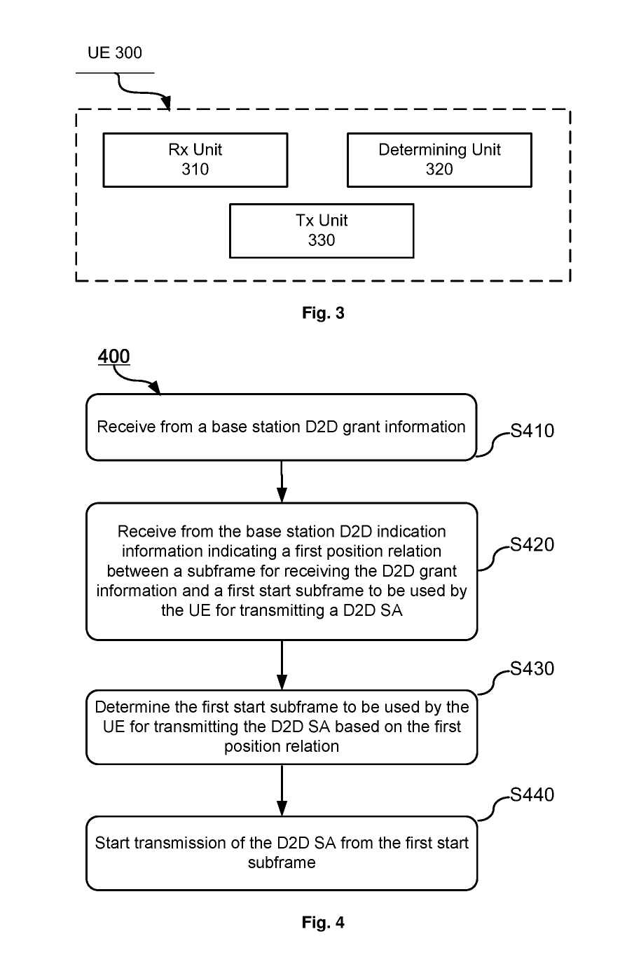

FIG. 4 is a flowchart illustrating a method 400 in a UE according to an embodiment of the present disclosure. It is to be noted that all the features described above in connection with the above embodiment of the UE 300 also apply to the following method embodiment. The method 400 can be performed by the above UE 300 and include the following steps.

At step S410, Device-to-Device (D2D) grant information is received from a base station.

At step S420, D2D indication information is received from the base station, indicating a first position relation between a subframe for receiving the D2D grant information and a first start subframe to be used by the UE for transmitting a D2D Scheduling Assignment (SA).

At step S430, the first start subframe to be used by the UE for transmitting the D2D SA is determined based on the first position relation.

At step S440, transmission of the D2D SA is started from the first start subframe.

Optionally, the D2D indication information can further indicate a second position relation between the subframe for receiving the D2D grant information and a second start subframe to be used by the UE for transmitting a D2D data. The method 400 can further include: determining the second start subframe to be used by the UE for transmitting the D2D data based on the second position relation; and starting transmission of the D2D data from the second start subframe.

Alternatively, the method 400 can further include: receiving from the base station further D2D grant information; and receiving from the base station further D2D indication information indicating a second position relation between the subframe for receiving the D2D grant information and a second start subframe to be used by the UE for transmitting a D2D data. The method 400 can further include: determining the second start subframe to be used by the UE for transmitting the D2D data based on the second position relation; and starting transmission of the D2D data from the second start subframe.

FIG. 5 is a block diagram of a UE 500 according to an embodiment of the present disclosure. As shown, the UE 500 includes a receiving unit 510, a determining unit 520 and a transmitting unit 530.

The receiving unit 510 is configured to receive from a base station Device-to-Device (D2D) grant information.

The determining unit 520 is configured to determine a first start subframe to be used by the UE for transmitting a D2D Scheduling Assignment (SA) based on a first predetermined relation between a subframe for receiving the D2D grant information and the first start subframe to be used by the UE for transmitting the D2D SA.

The transmitting unit 530 is configured to start transmission of the D2D SA from the first start subframe.

Optionally, the transmitting unit 530 is further configured to start transmission of a D2D data from the first start subframe.

In an embodiment, the first start subframe is the first subframe, subsequent to a subframe for receiving the D2D grant information, among subframes pre-allocated for D2D traffic.

Alternatively, the first start subframe is the k-th subframe subsequent to a subframe for receiving the D2D grant information, where k is an integer larger than or equal to 1.

Alternatively, the determining unit 520 is further configured to determine a second start subframe to be used by the UE for transmitting a D2D data based on a second predetermined relation between a subframe for receiving the D2D grant information and the second start subframe to be used by the UE for transmitting the D2D data. The transmitting unit 530 is further configured to start transmission of the D2D data from the second start subframe.

In an embodiment, the second start subframe is the first subframe, subsequent to a subframe for receiving the D2D grant information, among subframes pre-allocated for D2D traffic.

Alternatively, the second start subframe is the m-th subframe subsequent to a subframe for receiving the D2D grant information, where m is an integer larger than or equal to 1.

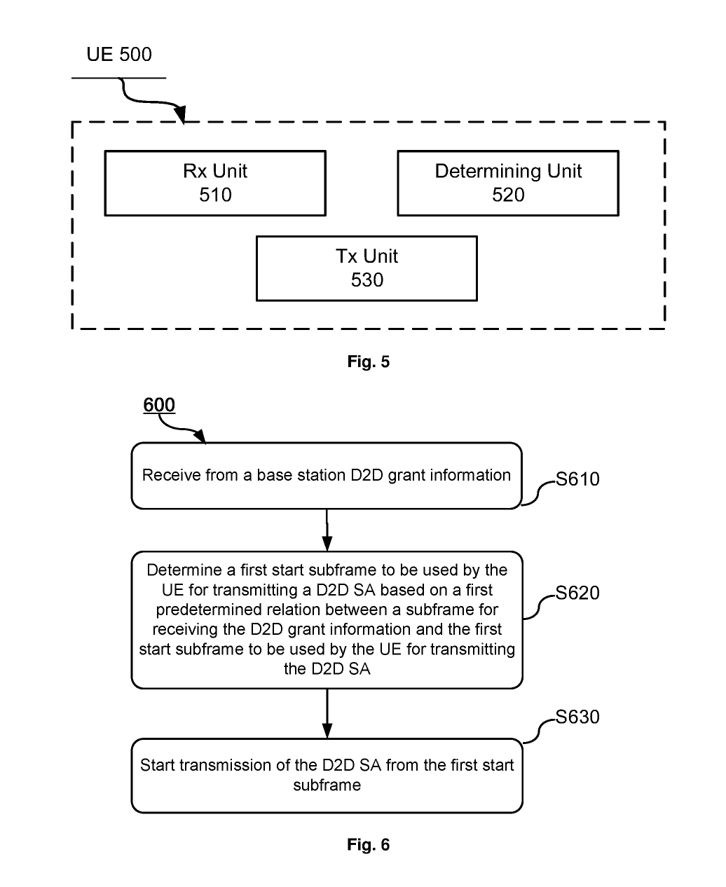

FIG. 6 is a flowchart illustrating a method 600 in a UE according to an embodiment of the present disclosure. It is to be noted that all the features described above in connection with the above embodiment of the UE 500 also apply to the following method embodiment. The method 600 can be performed by the above UE 500 and include the following steps.

At step S610, Device-to-Device (D2D) grant information is received from a base station.

At step S620, a first start subframe to be used by the UE for transmitting a D2D Scheduling Assignment (SA) is determined based on a first predetermined relation between a subframe for receiving the D2D grant information and the first start subframe to be used by the UE for transmitting the D2D SA.

At step S630, transmission of the D2D SA is started from the first start subframe.

Optionally, the method 600 can further include: starting transmission of a D2D data from the first start subframe.

In an embodiment, the first start subframe is the first subframe, subsequent to a subframe for receiving the D2D grant information, among subframes pre-allocated for D2D traffic.

Alternatively, the first start subframe is the k-th subframe subsequent to a subframe for receiving the D2D grant information, where k is an integer larger than or equal to 1.

Alternatively, the method 600 further comprises: determining a second start subframe to be used by the UE for transmitting a D2D data based on a second predetermined relation between a subframe for receiving the D2D grant information and the second start subframe to be used by the UE for transmitting the D2D data; and starting transmission of the D2D data from the second start subframe.

In an embodiment, the second start subframe is the first subframe, subsequent to a subframe for receiving the D2D grant information, among subframes pre-allocated for D2D traffic.

Alternatively, the second start subframe is the m-th subframe subsequent to a subframe for receiving the D2D grant information, where m is an integer larger than or equal to 1.

With the embodiments according to the present disclosure, a UE can determine a start subframe for D2D transmission (D2D SA and/or D2D data) based on a subframe position relation between a subframe used for D2D grant information and the start subframe for D2D transmission. Here, the subframe position relation can be dynamically indicated by D2D indication information received from a base station, or can be pre-determined statically.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” means a mobile communication data and control exchange center with a large transmit power and a wide coverage area and including functions such as resource allocation/scheduling, data reception/transmission and the like. The term “user equipment” means a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure.

This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1-3. (canceled)

4. A method in a User Equipment (UE), comprising:
receiving from a base station Device-to-Device (D2D) grant information;
determining a first start subframe to be used by the UE for transmitting a D2D Scheduling Assignment (SA) based on a first predetermined relation between a subframe for receiving the D2D grant information and the first start subframe to be used by the UE for transmitting the D2D SA; and
starting transmission of the D2D SA from the first start subframe.

5. The method of claim 4, further comprising:
starting transmission of a D2D data from the first start subframe.

6. The method of claim 4, wherein the first start subframe is the first subframe, subsequent to a subframe for receiving the D2D grant information, among subframes pre-allocated for D2D traffic.

7. The method of claim 4, wherein the first start subframe is the k-th subframe subsequent to a subframe for receiving the D2D grant information, where k is an integer larger than or equal to 1.

8. The method of claim 4, further comprising:
determining a second start subframe to be used by the UE for transmitting a D2D data based on a second predetermined relation between a subframe for receiving the D2D grant information and the second start subframe to be used by the UE for transmitting the D2D data; and
starting transmission of the D2D data from the second start subframe.

9. The method of claim 8, wherein the second start subframe is the first subframe, subsequent to a subframe for receiving the D2D grant information, among subframes pre-allocated for D2D traffic.

10. The method of claim 8, wherein the second start subframe is the m-th subframe subsequent to a subframe for receiving the D2D grant information, where m is an integer larger than or equal to 1.

11. A User Equipment (UE), comprising:
receiving circuitry configured to receive from a base station Device-to-Device (D2D) grant information;
determining circuitry configured to determine a first start subframe to be used by the UE for transmitting a D2D Scheduling Assignment (SA) based on a first predetermined relation between a subframe for receiving the D2D grant information and the first start subframe to be used by the UE for transmitting the D2D SA; and
transmitting circuitry configured to start transmission of the D2D SA from the first start subframe.

12. The UE of claim 11, wherein the transmitting circuitry is further configured to start transmission of a D2D data from the first start subframe.

13. The UE of claim 11, wherein the first start subframe is the first subframe, subsequent to a subframe for receiving the D2D grant information, among subframes pre-allocated for D2D traffic.

14. The UE of claim 11, wherein the first start subframe is the k-th subframe subsequent to a subframe for receiving the D2D grant information, where k is an integer larger than or equal to 1.

15. The UE of claim 11, wherein
the determining circuitry is further configured to determine a second start subframe to be used by the UE for transmitting a D2D data based on a second predetermined relation between a subframe for receiving the D2D grant information and the second start subframe to be used by the UE for transmitting the D2D data; and
the transmitting circuitry is further configured to start transmission of the D2D data from the second start subframe.

16. The UE of claim 15, wherein the second start subframe is the first subframe, subsequent to a subframe for receiving the D2D grant information, among subframes pre-allocated for D2D traffic.

17. The UE of claim 15, wherein the second start subframe is the m-th subframe subsequent to a subframe for receiving the D2D grant information, where m is an integer larger than or equal to 1.

18. A method in a base station, comprising:
transmitting to a User Equipment (UE) Device-to-Device (D2D) grant information; and
transmitting to the UE D2D indication information indicating a first position relation between a subframe for transmitting the D2D grant information and a first start subframe to be used by the UE for transmitting a D2D Scheduling Assignment (SA).

19. The method of claim 18, wherein:
the D2D indication information further indicates a second position relation between the subframe for transmitting the D2D grant information and a second start subframe to be used by the UE for transmitting a D2D data.

20. The method of claim 18, further comprising:
transmitting to the UE further D2D grant information; and
transmitting to the UE further D2D indication information indicating a second position relation between the subframe for transmitting the D2D grant information and a second start subframe to be used by the UE for transmitting a D2D data.

21. (canceled)

22. A base station, comprising:
first transmitting circuitry configured to transmit to a User Equipment (UE) Device-to-Device (D2D) grant information; and
second transmitting circuitry configured to transmit to the UE D2D indication information indicating a first position relation between a subframe for transmitting the D2D grant information and a first start subframe to be used by the UE for transmitting a D2D Scheduling Assignment (SA).

23. The base station of claim 22, wherein:
the D2D indication information further indicates a second position relation between the subframe for transmitting the D2D grant information and a second start subframe to be used by the UE for transmitting a D2D data.

24. The base station of claim 22, wherein:
the first transmitting circuitry is further configured to transmit to the UE further D2D grant information; and
the second transmitting circuitry is further configured to transmit to the UE further D2D indication information indicating a second position relation between the subframe for transmitting the D2D grant information and a second start subframe to be used by the UE for transmitting a D2D data.
